(19) United States
(12) Patent Application Publication
(10) Pub. No.: US 2006/0080574 A1
(43) Pub. Date: Apr. 13, 2006

(54) Redundant data storage reconfiguration

(76) Inventors: Yasushi Saito, Mountain View, CA (US); Svend Frolund, Viborg (DK)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/961,570

(22) Filed: Oct. 8, 2004

(51) Int. Cl. G06F 11/00

(52) U.S. Cl. 714/11

(57) ABSTRACT

In one embodiment, a method of reconfiguring a redundant data storage system is provided. A plurality of data segments are redundantly stored by a first group of storage devices, at least a quorum of storage devices of the first group each storing at least a portion of each data segment or redundant data. A second group of storage devices is formed, the second group having different membership from the first group. A data segment is identified among the plurality for which a consistent version is not stored by at least a quorum of the second group. At least a portion of the identified data segment or redundant data is written to at least one of the storage devices of the second group thereby at least a quorum of the second group stores a consistent version of the identified data segment.

### FIELD OF THE INVENTION

The present invention relates to the field of data storage and, more particularly, to fault tolerant data replication.

### BACKGROUND OF THE INVENTION

Enterprise-class data storage systems differ from consumer-class storage systems primarily in their requirements for reliability. For example, a feature commonly desired for enterprise-class storage systems is that the storage system should not lose data or stop serving data in all circumstances that fall short of a complete disaster. To fulfill these requirements, such storage systems are generally constructed from customized, very reliable, hot-swappable hardware components. Their software, including the operating system, is typically built from the ground up. Designing and building the hardware components is time-consuming and expensive, and this, coupled with relatively low manufacturing volumes is a major factor in the typically high prices of such storage systems. Another disadvantage to such systems is lack of scalability of a single system. Customers typically pay a high up-front cost for even a minimum disk array configuration, yet a single system can support only a finite capacity and performance. Customers may exceed these limits, resulting in poorly performing systems or having to purchase multiple systems, both of which increase management costs.

It has been proposed to increase the fault tolerance of off-the-shelf or commodity storage system components through the use of data replication or erasure coding. However, this solution requires coordinated operation of the redundant components and synchronization of the replicated data.

Therefore, what is needed are improved techniques for storage environments in which redundant devices are provided or in which data is replicated. It is toward this end that the present invention is directed.

### SUMMARY OF THE INVENTION

The present invention provides techniques for redundant data storage reconfiguration. In one embodiment, a method of reconfiguring a redundant data storage system is provided. A plurality of data segments are redundantly stored by a first group of storage devices. At least a quorum of storage devices of the first group each store at least a portion of each data segment or redundant data. A second group of storage devices is formed, the second group having different membership from the first group. A data segment is identified among the plurality for which a consistent version is not stored by at least a quorum of the second group. At least a portion of the identified data segment or redundant data is written to at least one of the storage devices of the second group. Thereby at least a quorum of the second group stores a consistent version the identified data segment.

In another embodiment, a data segment is redundantly stored by a first group of storage devices. At least a quorum of storage devices of the first group each storing at least a portion of the data segment or redundant data. A second group of storage devices is formed, the second group having different membership from the first group. At least one member of the second group is identified that does not have at least a portion of the data segment or redundant data that is consistent with data stored by other members of the second group. At least a portion of the data segment or redundant data is written to the at least one member of the second group.

In yet another embodiment, a data segment is redundantly stored by a first group of storage devices, at least a quorum of storage devices of the first group each storing at least a portion of the data segment or redundant data. A second group of storage devices is formed, the second group having different membership from the first group. If not every quorum of the first group of the storage devices is a quorum of the second group, at least a portion of the data segment or redundant data is written to at least one of the storage devices of the second group. Otherwise, if every quorum of the first group of the storage devices is a quorum of the second group, the writing is skipped.

The data may be replicated or erasure coded. Thus, the redundant data may be replicated data or parity data. Computer readable medium comprising computer code may implement any of the methods disclosed herein. These and other embodiments of the invention are explained in more detail herein.

### BRIEF DESCRIPTION OF THE DRAWINGS

FIG. 1 illustrates an exemplary storage system including multiple redundant storage device nodes in accordance with an embodiment of the present invention;

FIG. 2 illustrates an exemplary storage device for use in the storage system of FIG. 1 in accordance with an embodiment of the present invention;

FIG. 3 illustrates an exemplary flow diagram of a method for reconfiguring a data storage system in accordance with an embodiment of the present invention;

FIG. 4 illustrates an exemplary flow diagram of a method for forming a new group of storage devices in accordance with an embodiment of the present invention;

FIG. 5 illustrates an exemplary flow diagram of a method for ensuring that at least a quorum of a group of storage devices collectively stores a consistent version of replicated data in accordance with an embodiment of the present invention; and

FIG. 6 illustrates an exemplary flow diagram of a method for ensuring that at least a quorum of a group of storage devices collectively stores a consistent version of erasure coded data in accordance with an embodiment of the present invention.

### DETAILED DESCRIPTION OF A PREFERRED EMBODIMENT

The present invention provides for reconfiguration of storage environments in which redundant devices are provided or in which data is stored redundantly. A plurality of storage devices is expected to provide reliability and performance of enterprise-class storage systems, but at lower cost and with better scalability. Each storage device may be constructed of commodity components. Operations of the storage devices may be coordinated in a decentralized manner.

From the perspective of applications requiring storage services, a single, highly-available copy of the data is presented, though the data is stored redundantly. Techniques are provided for accommodating failures and other behaviors, such as device decommissioning or device recovery after a failure, in a manner that is substantially transparent to applications requiring storage services.

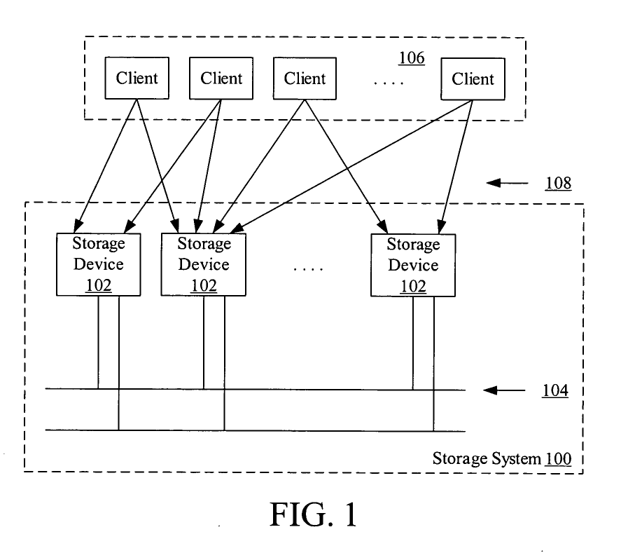

FIG. 1 illustrates an exemplary storage system 100 including multiple storage devices 102 in accordance with an embodiment of the present invention. The storage devices 102 communicate with each other via a communication medium 104, such as a network (e.g., using Remote Direct Memory Access (RDMA) over Ethernet). One or more clients 106 (e.g., servers) access the storage system 100 via a communication medium 108 for accessing data stored therein by performing read and write operations. The communication medium 108 may be implemented by direct or network connections using, for example, iSCSI over Ethernet, Fibre Channel, SCSI or Serial Attached SCSI protocols. While the communication media 104 and 108 are illustrated as being separate, they may be combined or connected to each other. The clients 106 may execute application software (e.g., email or database application) that generates data and/or requires access to the data.

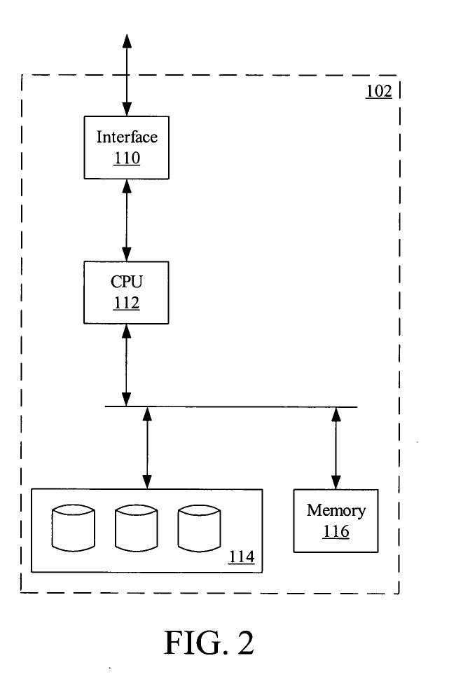

FIG. 2 illustrates an exemplary storage device 102 for use in the storage system 100 of FIG. 1 in accordance with an embodiment of the present invention. As shown in FIG. 2, the storage device 102 may include a network interface 110, a central processing unit (CPU) 112, mass storage 114, such as one or more hard disks, and memory 116, which is preferably non-volatile (e.g., NV-RAM). The interface 110 enables the storage device 102 to communicate with other devices 102 of the storage system 100 and with devices external to the storage system 100, such as the servers 106. The CPU 112 generally controls operation of the storage device 102. The memory 116 generally acts as a cache memory for temporarily storing data to be written to the mass storage 114 and data read from the mass storage 114. The memory 116 may also store timestamps and other information associated with the data, as explained more detail herein.

Preferably, each storage device 102 is composed of off-the-shelf or commodity hardware so as to minimize cost. However, it is not necessary that each storage device 102 is identical to the others. For example, they may be composed of disparate parts and may differ in performance and/or storage capacity.

To provide fault tolerance, data is stored redundantly within the storage system. For example, data may be replicated within the storage system 100. In an embodiment, data is divided into fixed-size segments. For each data segment, at least two different storage devices 102 in the system 100 are designated for storing replicas of the data, where the number of designated stored devices and, thus, the number of replicas, is given as “M.” For a write operation, a new value for a segment is stored at a majority of the designated devices 102 (e.g., at least two devices 102 if M is two or three). For a read operation, the value stored in a majority of the designated devices is discovered and returned. The group of devices designated for storing a particular data segment is referred to herein as a segment group. Thus, in the case of replicated data, to ensure reliable and verifiable reads and writes, a majority of the devices in the segment group must participate in processing a request for the request to complete successfully. In reference to replicated data, the terms “quorum” and “majority” are used interchangeably herein. Also, in reference to replicated data, the terms data “segment” and data “block” are used interchangeably herein.

As another example of storing data redundantly, data may be stored in accordance with erasure coding. For example, m, n Reed-Solomon erasure coding may be employed, where m and n are both positive integers such that m<n. In this case, a data segment may be divided into blocks which are striped across a group of devices that are designated for storing the data. Erasure coding stores m data blocks and p parity blocks across a set of n storage devices, where n=m+p. For each set of m data blocks that is striped across a set of m storage devices, a set of p parity blocks is stored on a set of p storage devices. An erasure coding technique for the array of independent storage devices uses a quorum approach to ensure that reliable and verifiable reads and writes occur. The quorum approach requires participation by at least a quorum of the n devices in processing a request for the request to complete successfully. The quorum is at least m+p/2 of the devices if p is even, and m+(p+1)/2 if p is odd. From the data blocks that meet the quorum condition, any m of the data or parity blocks can be used to reconstruct the m data blocks.

For coordinating actions among the designated storage devices 102, timestamps are employed. In one embodiment, a timestamp associated with each data or parity block at each storage device indicates the time at which the data block was last updated (i.e. written to). In addition, a record is maintained of any pending updates to each of the blocks. This record may include another timestamp associated with each data or parity block that indicates a pending write operation. An update is pending when a write operation has been initiated, but not yet completed. Thus, for each block of data at each storage device, two timestamps may be maintained. The timestamps stored by a storage device are unique to that storage device.

For generating the timestamps, each storage device 102 includes a clock. This clock may either be a logic clock that reflects the inherent partial order of events in the system 100 or it may be a real-time clock that reflects “wall-clock” time at each device. Each timestamp preferably also has an associated identifier that is unique to each device 102 so as to be able to distinguish between otherwise identical timestamps. For example, each timestamp may include an eight-byte value that indicates the current time and a four-byte identifier that is unique to each device 102. If using real-time clocks, these clocks are preferably synchronized across the storage devices 102 so as to have approximately the same time, though they need not be precisely synchronized. Synchronization of the clocks may be performed by the storage devices 102 exchanging messages with each other or by a centralized application (e.g., at one or more of the servers 106) sending messages to the devices 102.

In particular, each storage device 102 designated for storing a particular data block stores a value for the data block, given as “val” herein. Also, for the data block, each storage device stores two timestamps, given as “valTS” and “ordTS.” The timestamp valTS indicates the time at which the data value was last updated at the storage device. The timestamp ordTs indicates the time at which the last write operation was received. If a write operation to the data was initiated but not completed at the storage device, the timestamp ordTS for the data is more recent than the timestamp valTS. Otherwise, if there are no such pending write operations, the timestamp valTS is greater than or equal to the timestamp ordTS.

In an embodiment, any device may receive a read or write request from an application and may act as a coordinator for servicing the request. A write operation is performed in two phases for replicated data and for erasure coded data. In the first phase, a quorum of the devices in a segment group update their ordTS timestamps to indicate a new ongoing update to the segment. In the second phase, a quorum of the devices of the segment group update their data value, val, and their valTS timestamp. For the write operation for erasure-coded data, the devices in a segment group may also log the updated value of their data or parity blocks without overwriting the old values until confirmation is received in an optional third phase that a quorum of the devices in the segment group have stored their new values.

A read request may be performed in one phase in which a quorum of the devices in the segment group return their timestamps, valTs and ordTs, and value, val to the coordinator. The request is successful when the timestamps ordTs and valTs returned by the quorum of devices are all identical. Otherwise, an incomplete past write is detected during a read operation and a recovery operation is performed. In an embodiment of the recovery operation for replicated data, the data value, val, with the most-recent timestamp among a quorum in the segment group is discovered and is stored at at least a majority of the devices in the segment group. In an embodiment of the recovery operation for erasure-coded data, the logs for the segment group are examined to find the most-recent segment for which sufficient data is available to fully reconstruct the segment. This segment is then written to at least a quorum in the segment group. Read, write and recovery operations which may be used for replicated data are described in U.S. patent application Ser. No. 10/440,548, filed May 16, 2003, and entitled, “Read, Write and Recovery Operations for Replicated Data,” the entire contents of which are hereby incorporated by reference. Read, write and recovery operations which may be used for erasure-coded data are described in U.S. patent application Ser. No. 10/693,758, filed Oct. 23, 2003, and entitled, “Methods of Reading and Writing Data,” the entire contents of which are hereby incorporated by reference.

When a storage device 102 fails, recovers after a failure, is decommissioned, is added to the system 100, is inaccessible due to a network failure or when a storage device 102 is determined to experience a persistent hot-spot, these conditions indicate need for a change to any segment group of which the affected storage device 102 is a member. In accordance with an embodiment of the invention, such a segment group is reconfigured to have a different quorum requirement. Thus, while the read, write and recovery operations described above enable masking of failures or slow storage devices, changes to the membership of the segment groups and accompanying reconfiguration permits the system to withstand a greater number of failures than otherwise would be possible if the quorum requirements remained fixed.

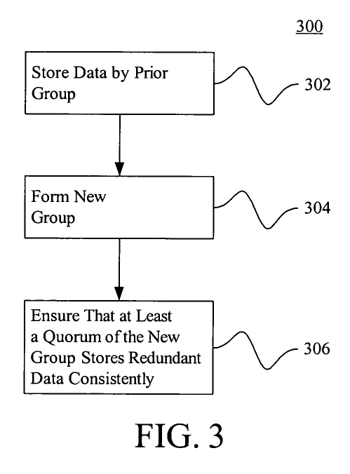

FIG. 3 illustrates an exemplary flow diagram of a method 300 for reconfiguring a data storage system in accordance with an embodiment of the present invention. The method 300 reconfigures a segment group to reflect a change in membership of the group and ensures that the data is stored consistently by the group after the change. This allows the quorum requirement for performing data transactions by a segment group to be changed based on the new group membership. For example, consider an embodiment in which a segment group for replicated data has five members, in which case, at least three of the devices 102 are needed to form a majority for performing read and write operations. However, if the system is appropriately reconfigured for a group membership of three, then only two of the devices 102 are needed to form a majority for performing read and write operations. Thus, by reconfiguring the segment group, the system is able to tolerate more failures than would be the case without the reconfiguration.

Consistency of the data stored by the group after the change is needed for the new group to reliably and verifiably service read and write requests received after the group membership change. Replicated data is consistent when the versions stored by different storage devices are identical. Replicated data is inconsistent if an update has occurred to a version of the data and not to another version so that the versions are no longer identical. Erasure coded data is consistent when data or parity blocks are derived from the same version of a segment. Erasure coded data is inconsistent if an update has occurred to a data block or parity information for a segment but no corresponding update has been made to another data block or parity information for the same segment. As explained in more detail herein, consistency of a redundantly stored version of a data segment can be determined by examining timestamps associated with updates to the data segment which have occurred at the storage devices that are assigned to store the data segment.

The membership change for a segment group is referred to herein as being from a “prior” or “first” group membership to a “new” or “second” group membership. The method 300 is performed by a redundant data storage system such as the system 100 of FIG. 1 and may run independently for each segment group.

In a step 302, redundant data is stored by a prior group. At least a quorum of the storage devices of this group each stores at least a portion of a data segment or redundant data. For example, in the case of replicated data, this means that at least a majority of the storage devices in this group store replicas of the data (i.e. data or a redundant copy of the data); and, in the case of erasure coded data, at least a quorum of the storage devices in this group each store a data block or redundant parity data.

In a step 304, a new group is formed. A new segment group membership is typically formed when a change in membership of a particular “prior” group occurs. For example, a system administrator may determine that a storage device has failed and is not expected to recover or may determine that a new storage device is added. As another example, a particular storage device of the group may detect the failure of another storage device of the group when the storage device continues to fail to respond to messages sent by the particular storage device for a period of time. As yet another example, a particular storage device of the group may detect the recovery of a previously failed device of the group when the particular storage device receives a message from the previously failed device.

A particular one of the storage devices of the segment group may initiate formation of a new group in step 304. This device may be designated by the system administrator or may have detected a change in membership of the prior group.

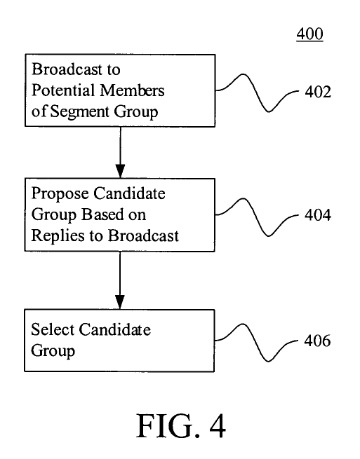

FIG. 4 illustrates an exemplary flow diagram of a method 400 for forming a new group of storage devices in accordance with an embodiment of the present invention. In a step 402, the initiating device sends a broadcast message to potential members of the new group. Each segment group may be identified by a unique segment group identification. For each data segment, a number of devices serve as potential members of the segment group, though at any one time, the members of the segment group may include a subset of the potential members. Each storage device preferably stores a record of which segment groups it may potentially become a member of and a record of the identifications of other devices that are potential members. The broadcast message sent in step 302 preferably identifies the particular segment group using the segment group identification and is sent to all potential members of the segment group.

The potential members that receive the broadcast message and that are operational send a reply message to the initiating device. The initiating device may receive a reply from some or all of the devices to which the broadcast message was sent.

In a step 404, the initiating device proposes a candidate group based on replies to its broadcast message. The candidate group proposed in step 404 preferably includes all of the devices from which the initiating device received a response. If all of the devices receive the broadcast message and reply, then the candidate group preferably includes all of the devices. However, if only some of the devices respond within a predetermined period of time, then the candidate group includes only those devices. Alternatively, rather than including all of the responding devices in the candidate group, fewer than all of the responding devices may be selected for the candidate group. This may be advantageous when there are more potential group members than are needed to safely and securely store the data. The initiating device proposes the candidate group by sending a message that identifies the membership of the candidate group to all of the members of the candidate group.

Each device that receives the message proposing the candidate group determines whether the candidate group includes at least a quorum of the prior group before accepting the candidate group. In addition, each storage device preferably maintains a list of ambiguous candidate groups to which the proposed candidate group is added. An ambiguous candidate group is one that was proposed, but not accepted. Each device also determines whether the candidate group includes at least a majority of any prior ambiguous candidate groups prior to accepting the candidate group. Thus, if the candidate group includes at least a quorum of the prior group and includes at least a majority of any prior ambiguous candidate groups, then the candidate group is accepted. This tracking of the prior ambiguous candidate groups helps to prevent two disjoint groups of storage devices from being assigned to store a single data segment. Each device that accepts a candidate group responds to the initiating device that it accepts the candidate group.

In step 406, once the initiating device receives a response from each member of an accepted candidate group, the initiating device sends a message to each member device, informing it that the candidate group has been accepted and is, thus, the new group for the particular data segment. In response, each member may erase or discard its list of ambiguous candidate groups for the data segment. If not all of the members of the candidate group respond with acceptance of the candidate group, the initiating device may restart the method beginning again at step 402 or at step 404. If the initiating device fails while running the method 400, then another device will detect the failure and restarts this method.

As a result of the method 400, each device of the new group has agreed upon and recorded the membership of the new group. At this point, the devices still also have a record of the membership of the prior group. Thus, each storage device maintains a list of the segment groups of which it is an active member.

In accordance with an embodiment of the invention, one or more witness devices may be utilized during the method 400. Preferably, one witness device is assigned to each segment group, though additional witnesses may be assigned. Each witness device participates in the message exchanges for the method 400, but does not store any portion of the data segment. Thus, the witness devices receive the broadcast message in step 402 and respond. In addition, the witness devices receive the proposed candidate group membership in step 404 and determine whether to accept the candidate membership. The witness devices also maintain a list of prior ambiguous candidate group memberships for determining whether to accept a candidate group membership. By increasing the number of devices that participate in the method 400, reliability of the membership selection is increased. The inclusion of witness devices is most useful when a small number of other devices participate in the method. Particularly, when a prior segment membership has only two members and the segment group transitions to a new group membership having only one member, one or more witness devices can cast a tie-breaker vote to allow a candidate group membership of one device to be created even though one device is not a majority of the two devices of the prior group membership.

Once the new group membership of storage devices is formed for a segment group, an attempt is made to remove the prior membership group so that future requests can complete only by contacting a quorum of the new membership group. Before the prior group can be removed, however, the segment group needs to be synchronized. Synchronization requires that a consistent version of the segment is made available for read and write accesses to the new group. For example, consider an embodiment in which a prior group membership of storage devices 102 has five members, A, B, C, D and E and that A, B and C form a majority that has a consistent version of replicated data (D and E missed the most recent write operations, thus, their data is out of date). Assume that a new group membership is then formed that includes only devices C, D and E. In this case, at least a majority of the new group needs to store a consistent version of the data, though preferably all of the new group store a consistent version of the data. Accordingly, at least one of D and E, and preferably both, need to be updated with the most recent version of the data to ensure that at least a majority of the new group store consistent versions of the data.

Thus, referring to FIG. 3, after the new group membership is formed in step 304, consistency of the redundant data is ensured in a step 306. This is referred to herein as data synchronization and is accomplished by ensuring that at least a majority of the new group (in the case of redundant data) or a quorum of the new group (in the case of erasure coded data) stores the redundant data consistently.

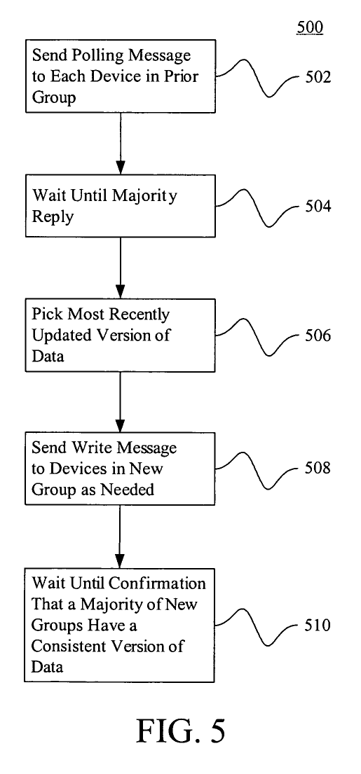

FIG. 5 illustrates an exemplary flow diagram of a method 500 for ensuring that at least a majority of storage devices store replicated data consistently. In a step 502, a particular device sends a message to each device in the prior group. The particular device that sends the polling message is a coordinator for the synchronization process and is preferably the same device that initiates the formation of a new group membership in step 304 of FIG. 3.

The polling message identifies a particular data block and instructs each device that receives the message to return its current value for the data, val, and its associated two timestamps valTS and ordTS. As mentioned, the valTS timestamps identify the most-recently updated version of the data and the ordTS timestamp identifies any initiated but uncompleted write operations to the data. The ordTS timestamps are collected for future use in restoring the most-recent ordTS timestamp to the new group in case there was a pending uncompleted write operation at the time of the reconfiguration. Otherwise, if there was no pending write operation, the most-recent ordTS timestamp of the majority will be the same as the most-recent valTS timestamp.

In step 504, the coordinator waits until it receives replies from at least a majority of the devices of the prior group membership. In a step 506, the most recently updated version of the data is selected from among the replies. The most-recently updated version of the data is identified by the timestamps, and particularly, by having the highest value for valTS. By waiting for a majority of the devices of the prior group to respond in step 504, the method ensures that the selected version of the data is the version for the most recent successful write operation.

In step 508, the coordinator sends a write message to storage devices of the new group membership. This write message identifies the particular data block and includes the most-recent value for the block and the most-recent valTS and ordTS timestamps for the block which were obtained from the prior group. The write message may be sent to each storage device of the new group, though preferably the write message is not sent to storage devices of the new group that are determined to already have the most-recent version of the data. This can be determined from the replies received in step 504. Also, in certain circumstances, all, or at least a quorum of the storage devices in the new group may already have a consistent version of the data. Thus, in step 508, write messages need not be sent. For example, when every device of the prior group stores the most-recent version of the data and the new group is a subset of the prior group, then no write messages need to be sent to the new group.

In response to this write message, each device that receives the message compares the timestamp ordTS received in the write message to its current value of the timestamp ordTS for the data block. If the ordTS timestamp received in the write message is more recent than the current value of the timestamp ordTS for the data block, then the device replaces its current value of the timestamp ordTS with the value of the timestamp ordTS received in the write message. Otherwise, the device retains its current value of the ordTS timestamp.

Also, each device that receives the message compares the timestamp valTS received in the write message to its current value of the timestamp valTS for the data block. If the timestamp valTS received in the write message is more recent than the current value of the timestamp valTS for the data block, then the device replaces its current value of the timestamp valTS with the value of the timestamp valTS received in the write message and also replaces its current value for the data block with the value for the data block received in the write message. Otherwise, the device retains its current values of the timestamp valTS and the data block. If the device did not previously store any version of the data block, it simply stores the most-recent value of the block along with the most-recent timestamps valTS and ordTS for the block which are received in the write message.

In step 510, the coordinator waits until at least majority of the storage devices in the new group membership have either replied that they have successfully responded to the write message or otherwise have been determined to already have a consistent version of the data. This condition indicates that the synchronization process was successful and, thus, the new group is now ready to respond to read and write requests to the data block. The initiator may then send a message to the members of the prior group to inform them that they can remove the prior group membership from their membership records or otherwise deactivate the prior group. If a majority does not have a consistent version of the data in step 510, this indicates a failure of the synchronization process, in which case, the method 500 may be tried again or it may indicate that a different new group membership needs to be formed, in which case, the method 300 may be performed again. In another embodiment, synchronization may be considered successful only if all of the devices have been determined to already have a consistent version of the data.

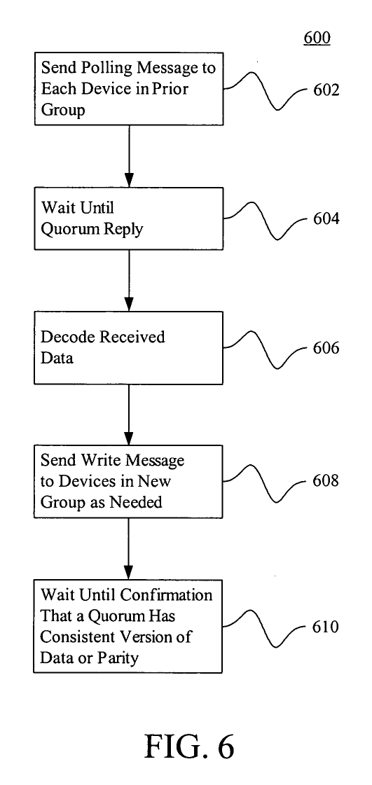

FIG. 6 illustrates an exemplary flow diagram of a method 600 for ensuring that at least a quorum of storage devices store erasure coded data consistently. For erasure coded data, the devices in the segment group each store a particular data block belonging to a particular data segment or a redundant parity block for the segment. In a step 602, a particular device sends a polling message to each device in the prior group. The particular device that sends the polling message is a coordinator for the synchronization process and is preferably the same device that initiates the formation of a new group membership in step 304 of FIG. 3.

The polling message identifies a particular data segment or block and instructs each device that receives the message to return its current value for the data (which may be a data block or parity), val, and its associated two timestamps valTS and ordTS. As in the case of redundantly stored data, the ordTS timestamps are collected for future use in restoring the most-recent ordTS timestamp to the new group in case there was a pending uncompleted write operation at the time of the reconfiguration.

In step 604, the coordinator waits until it receives replies from at least a quorum of the devices of the prior group membership. In a step 606, assuming the quorum of the devices report the same most-recent valTS timestamp, the coordinator decodes the received data values to determine the value of any data or parity block which belongs to the data segment, but which needs to be updated. Where the prior group and the new group have the same number of members, this generally involves storing the appropriate data at any device which was added to the group. Where the prior group and the new group have a different number of members, this may include re-computing the erasure coding and possibly reconfiguring an entire data volume. For example, the data segment may be divided into a different number of data blocks or a different number of parity blocks may be used.

In step 608, the coordinator sends a write message to storage devices of the new group membership. Because each device of the new group stores a data block or parity that has a different value, val, than is stored by the other devices of the new group, any write messages sent in step 608 are specific to a device of the new group and include the data block or parity value that is assigned to the device. The write messages also include the most-recent valTS and ordTS timestamps for the segment which were obtained from the prior group. An appropriate write message may be sent to each storage device of the new group, though preferably the write message is not sent to storage devices of the new group that are determined to already have the most-recent version of their data block or parity. This can be determined from the replies received in step 604. In certain circumstances, all, or at least a quorum of the storage devices in the prior group may already have a consistent version of the data. In this case, no write messages need to be sent in step 608.

In response to this write message, each device that receives the message compares the timestamp ordTS received in the write message to its current value of the timestamp ordTS for the data block or parity. If the ordTS timestamp received in the write message is more recent than the current value of the timestamp ordTS for the data, then the device replaces its current value of the timestamp ordTS with the value of the timestamp ordTS received in the write message. Otherwise, the device retains its current value of the ordTS timestamp.

Also, each device that receives the message compares the timestamp valTS received in the write message to its current value of the timestamp valTS for the data block or parity. If the valTS timestamp is not in the log maintained by the device, then the device adds to its log the timestamp valTS and the value for the data block or parity received in the write message. Otherwise, the device retains its current contents of the log. If the device did not previously store any version of the data block or parity, it simply stores the most-recent value of the block along with the most-recent timestamps valTS and ordTS which are received in the write message.

In step 610, the coordinator waits until a quorum of the storage devices in the new group membership have either replied that they have successfully responded to the write message or otherwise have been determined to already have a consistent version of the appropriate data block or parity. This condition indicates that the synchronization process was successful and, thus, the new group is now ready to respond to read and write requests to the data segment. The initiator may then send a message to the members of the prior group membership to inform them that they can remove the prior group from their membership records or otherwise deactivate the prior group. If a quorum does not have a consistent version of the segment in step 610, this indicates a failure of the synchronization process, in which case, the method 600 may be tried again or it may indicate that a different new group membership needs to be formed, in which case, the method 300 may be performed again. In another embodiment, synchronization may be considered successful only if all of the devices have been determined to already have a consistent version of the data.

While the synchronization method 500 or 600 is being performed and until the group is deactivated, both the prior group and the new group are designated for storing the particular segment of data. Thus, any read or write operations performed in the meantime are required to be performed with a quorum of the prior group and with a quorum of the new group.

If a device which is acting as the coordinator for synchronization experiences a failure during the synchronization process, another device may resume the process. However, blocks that have been synchronized are preferably not synchronized again.

The methods 500 and 600 are sufficient for a single segment of data. However, a segment group may store multiple data segments. Thus, a change to the membership may require synchronization of multiple data segments. Accordingly, the method 500 or 600 may be performed for each segment of data which was stored by the prior group.

As mentioned, each storage device stores timestamps for each data block it stores. The timestamps may be stored in a table at each device in which the segment group identification for the data is also stored. Thus, the device which initiates the data synchronization for a new group membership may check its own timestamp table to identify all of the data blocks or segments associated with the particular segment group identification. The method 500 or 600 may then be performed for each data block or segment.

However, in some circumstances not all of the data segments assigned to a segment group will need to be updated as a result of the change to group membership. For example, a consistent version of a particular data segment may already be stored by all of the devices group in the segment, prior to performing the method 500 or 600. Thus, such data segments may be identified so as to avoid unnecessarily having to update them. This may be accomplished, for example, by identifying a data segment for which a consistent version is not stored by a quorum as in step 508 or 608. As explained above in reference to steps 508 and 608, no write messages need be sent for such a segment.

In an embodiment, in order to limit the size of the timestamp table, timestamps for only some of the data assigned to a storage device are stored in the timestamp table at the device. For the read, write and repair operations, the timestamps are used to disambiguate concurrent updates to the data and to detect and repair results of failures. Thus, timestamps may be discarded after each device holding a block of data or parity has acknowledged an update (i.e. where valTS=ordTS). The devices of a segment group may discard the timestamps for a data block or parity after all of the other members of the segment group have successfully updated their data. In this case, each storage device only maintains timestamps for data blocks that are actively being updated.

In this embodiment, the initiator of the data synchronization process for a new group membership may send a polling message to the members of the prior group that includes the particular segment group identification. Each storage device that receives this polling message responds by identifying all of the data blocks associated with the segment group identification that are included in its timestamp table. These are blocks that are currently undergoing an update or for which a failed update previously occurred. These blocks may be identified by each device that receives the polling message sending a list of block numbers to the initiator. The initiator then identifies the data blocks to be synchronized by taking the union of all of the blocks received in the replies. This set of blocks is expected to include only those data blocks that need to be synchronized. Data blocks associated with the segment group that do not appear in the list do not need to be synchronized since all of the devices in the prior group membership store a current and consistent version. Also, these devices comprise a quorum of the new group membership since step 304 of the method 300 requires the new group membership to comprise a quorum of the prior group membership. This is another way of identifying a data segment for which a consistent version is not stored by a quorum.

In an embodiment, each write operation may include an optional third phase that notifies each storage device the list of other devices in the segment group that successfully stored the new data block (or parity) value. These devices are referred to as a “respondent set” for a prior write operation on the segment. The respondent set can be stored on each device in conjunction with its timestamp table and can be used to distinguish between those blocks that must be synchronized before discarding the prior group membership and those that can wait until later. More particularly, in response to the polling message (sent in step 504 or 604) a storage device responds by identifying a segment as one that must be synchronized if the respondent set is not a quorum of the new group membership. The blocks identified in this manner may be updated using the method 500 or 600. Otherwise, the storage device may respond by identifying a block as one for which updating is optional when the respondent set is a quorum of the new group membership but is less than the entire new group. This is yet another way of identifying a data segment for which a consistent version is not stored by a quorum.

In certain circumstances, synchronization may be skipped entirely for a new segment group. In one embodiment, if every quorum of a prior segment group is a superset of a quorum in the new segment group, synchronization is skipped. This condition is referred to a quorum containment condition. This is the case for replicated data when the prior group membership has an even number of devices and the new group membership has one fewer devices because every majority of the prior group is also a majority of the new group. Quorum containment can also occur in the case of erasure coded data. Thus, in an embodiment, the initiator of the reconfiguration method 300 performs the step 306 by determining whether the quorum containment condition holds, and if so, the synchronization method 500 or 600 is not performed.

As mentioned, synchronization may be considered successful (in steps 510 and 610) only if a quorum of the new group is confirmed to store a consistent version of the data (or parity). Also, synchronization may be skipped for segments that are a confirmed to a store a consistent version of the data (or parity) through the quorum containment condition. In addition, some data may be identified (in steps 504 and 604) as ones for which synchronization is optional. In any of these cases, some of the devices of the new group membership may not have a consistent version of the data (even though at least a quorum does have a consistent version). In an embodiment, all of the devices in the new group are made to store a consistent version of the data. Thus, in an embodiment where synchronization is completed or skipped for a particular data block and some of the devices do not store a consistent version of the data, update operations are eventually performed on these devices so that this data is eventually brought current. This may be accomplished relatively slowly after the prior group membership has been discarded, in the background of other operations.

While the foregoing has been with reference to particular embodiments of the invention, it will be appreciated by those skilled in the art that changes in these embodiments may be made without departing from the principles and spirit of the invention, the scope of which is defined by the following claims.

What is claimed is:

1. A method of reconfiguring a redundant data storage system comprising:
redundantly storing a plurality of data segments by a first group of storage devices, at least a quorum of storage devices of the first group each storing at least a portion of each data segment or redundant data;
forming a second group of storage devices, the second group having different membership from the first group;
identifying a data segment among the plurality for which a consistent version is not stored by at least a quorum of the second group; and
writing at least a portion of the identified data segment or redundant data to at least one of the storage devices of the second group thereby at least a quorum of the second group stores a consistent version of the identified data segment.

2. The method according to claim 1, wherein the identified data segment is erasure coded.

3. The method according to claim 1, wherein the identified data segment is replicated.

4. The method according to claim 1, wherein said identifying is performed by examining timestamps stored at the storage devices of the second group.

5. The method according to claim 4, wherein the timestamps indicate an incomplete write operation.

6. The method according to claim 5, wherein the timestamps are provided by devices of the second group in response to a polling message.

7. The method according to claim 1, wherein said identifying is performed by sending a polling message to a storage device of the second group which responds by identifying the segment if a respondent set for a prior write operation on the segment is not a quorum of the second group.

8. The method according to claim 1, wherein if less than all of the devices in the second group store a consistent version of the identified data segment after said writing, performing one or more additional write operations until all of the devices in the second group store a consistent version.

9. The method according to claim 1, wherein said forming the second group comprises:
computing a candidate group of storage devices by a particular one of the storage devices; and
sending messages from the particular storage device to members of the candidate group for proposing the candidate group and receiving messages from members of the candidate group accepting the candidate group as the second group.

10. The method according to claim 1, wherein one or more witness devices that are not members of the second group participate in said forming the second group.

11. The method according to claim 10, wherein said forming the second group comprises:
computing a candidate group of storage devices by a particular one of the storage devices; and
sending messages from the particular storage device to members of the candidate group and to the one or more witness devices for proposing the candidate group and receiving messages from members of the candidate group and from one or more of the witness devices accepting the candidate group as the second group.

12. The method according to claim 1, wherein the second group comprises at least a quorum of the first group.

13. The method according to claim 1, wherein the second group is formed in response to a change in membership of the first group.

14. The method according to claim 13, wherein a storage device is added to the first group.

15. The method according to claim 13, wherein a storage device is removed from the first group.

16. A method of reconfiguring a redundant data storage system comprising:
redundantly storing a data segment by a first group of storage devices, at least a quorum of storage devices of the first group each storing at least a portion of the data segment or redundant data;
forming a second group of storage devices, the second group having different membership from the first group;
identifying at least one member of the second group that does not have at least a portion of the data segment or redundant data that is consistent with data stored by other members of the second group; and
writing at least a portion of the data segment or redundant data to the at least one member of the second group.

17. The method according to claim 16, wherein the data segment is erasure coded.

18. The method according to claim 16, wherein the data segment is replicated.

19. The method according to claim 16, wherein said identifying is performed by examining timestamps stored at the storage devices of the second group.

20. The method according to claim 19, wherein the timestamps indicate an incomplete write operation.

21. The method according to claim 20, wherein the timestamps are provided by devices of the second group in response to a polling message.

22. The method according to claim 16, wherein if less than all of the devices in the second group store a consistent version of the identified data segment after said writing, performing one or more additional write operations until all of the devices in the second group store a consistent version.

23. The method according to claim 16, wherein said forming the second group comprises:
computing a candidate group of storage devices by a particular one of the storage devices; and
sending messages from the particular storage device to members of the candidate group for proposing the candidate group and receiving messages from members of the candidate group accepting the candidate group as the second group.

24. The method according to claim 16, wherein one or more witness devices that are not members of the second group participate in said forming the second group.

25. The method according to claim 24, wherein said forming the second group comprises:
computing a candidate group of storage devices by a particular one of the storage devices; and
sending messages from the particular storage device to members of the candidate group and to the one or more witness devices for proposing the candidate group and receiving messages from members of the candidate group and from one or more of the witness devices accepting the candidate group as the second group.

26. The method according to claim 16, wherein the second group comprises at least a quorum of the first group.

27. The method according to claim 16, wherein the second group is formed in response to a change in membership of the first group.

28. The method according to claim 27, wherein a storage device is added to the first group.

29. The method according to claim 16, wherein a storage device is removed from the first group.

30. A method of reconfiguring a redundant data storage system comprising:
redundantly storing a data segment by a first group of storage devices, at least a quorum of storage devices of the first group each storing at least a portion of the data segment or redundant data;
forming a second group of storage devices, the second group having different membership from the first group; and
if not every quorum of the first group of the storage devices is a quorum of the second group, writing at least a portion of the data segment or redundant data to at least one of the storage devices of the second group and, otherwise, skipping said writing.

31. The method according to claim 30, wherein the data segment is erasure coded.

32. The method according to claim 30, wherein the data segment is replicated.

33. The method according to claim 30, wherein one or more witness devices that are not members of the second group participate in said forming the second group.

34. The method according to claim 33, wherein said forming the second group comprises:
computing a candidate group of storage devices by a particular one of the storage devices; and
sending messages from the particular storage device to members of the candidate group and to the one or more witness devices for proposing the candidate group and receiving messages from members of the candidate group and from one or more of the witness devices accepting the candidate group as the second group.

35. A computer readable medium comprising computer code for implementing a method of reconfiguring a redundant data storage system, the method comprising steps of:
redundantly storing a plurality of data segments by a first group of storage devices, at least a quorum of storage devices of the first group each storing at least a portion of each data segment or redundant data;
forming a second group of storage devices, the second group having different membership from the first group;
identifying a data segment among the plurality for which a consistent version is not stored by at least a quorum of the second group; and
writing at least a portion of the identified data segment or redundant data to at least one of the storage devices of the second group thereby at least a quorum of the second group stores a consistent version of the identified data segment.

36. A computer readable medium comprising computer code for implementing a method of reconfiguring a redundant data storage system, the method comprising steps of:
redundantly storing a data segment by a first group of storage devices, at least a quorum of storage devices of the first group each storing at least a portion of the data segment or redundant data;
forming a second group of storage devices, the second group having different membership from the first group;
identifying at least one member of the second group that does not have at least a portion of the data segment or redundant data that is consistent with data stored by other members of the second group; and
writing at least a portion of the data segment or redundant data to the at least one member of the second group.

37. A computer readable medium comprising computer code for implementing a method of reconfiguring a redundant data storage system, the method comprising steps of:
redundantly storing a data segment by a first group of storage devices, at least a quorum of storage devices of the first group each storing at least a portion of the data segment or redundant data;
forming a second group of storage devices, the second group having different membership from the first group; and
if not every quorum of the first group of the storage devices is a quorum of the second group, writing at least a portion of the data segment or redundant data to at least one of the storage devices of the second group and, otherwise, skipping said writing.
